(19) United States
(12) Patent Application Publication
(10) Pub. No.: US 2010/0065138 A1
(43) Pub. Date: Mar. 18, 2010

(54) FLUID CONTROL VALVE

(76) Inventor: Marc Hoffmann, Oetrange (LU)

Correspondence Address: DELPHI TECHNOLOGIES, INC;LEGAL STAFF - M/C 483-400-402, 5725 DELPHI DRIVE, PO BOX 5052, TROY, MI, 48007, US

(21) Appl. No.: 12/442,661

(22) PCT Filed: Oct. 2, 2007
(86) PCT No.: PCT/EP07/60476

§ 371 Date: Mar. 24, 2009

(30) Foreign Application Priority Data
Oct. 5, 2006 (GB) 0619627.3

(51) Int. Cl. F16K 11/00

(52) U.S. Cl. 137/597

(57) ABSTRACT

A fluid control valve comprising a valve body having a central bore provided with a plurality of radial apertures defining inlet and outlet ports, wherein at least one annular groove is formed in an outer periphery of the valve body in the region of one of said radial apertures, a filter being provided in said at least one annular groove, the filter comprising a perforated plate or membrane formed into a cylindrical shape and located in the annular bore, the perforated plate being held in place in the groove by retaining means, characterized in that the retaining means comprises an elongate resilient member located around the outer periphery of the perforated plate and adapted to apply a compressive biasing force against the plate.

The present invention relates to a fluid control valve and more particularly to a fluid control valve for controlling the flow of oil or hydraulic fluid to a hydraulic cam phaser.

Typically a fluid control valve for a hydraulic cam phaser comprises a generally cylindrical valve body having a central bore provided with radial apertures defining inlet and outlet ports, and a spool axially slidably mounted within the bore to provide selective fluid communication between selected pairs or groups of the inlet and outlet ports. A spring typically abuts against one end face of the spool to bias the spool in a first direction while an electromagnetic actuator is provided to apply a driving axial force to the other end face of the spool. An example of such a known fluid control valve is disclosed in US 2004/0182450 A1.

In order to avoid damage to the cam phaser mechanism it is desirable to provide filters in the inlet and/or outlet ports of the fluid control valve. In US 2004/0182450 A1 filters are provided in the form of a perforated plate associated with one or more of the ports, each plate being wrapped around the valve sleeve and located in a peripheral annular groove in the outer surface of the valve sleeve in the region of the respective port to cover the respective port. Each filter plate is held in place in its annular groove by means of a snap ring or retainer formed from thin spring steel bar bent into a circle. The ends of the snap ring are bent to extend in an axial direction to minimize vibration of the filter. The filter plate is of sufficient length to be wrapped around the annular groove with sufficient overlap to ensure a good seal while minimising pressure loss. The length of the overlapping portion is approximately 3 mm.

Due to the flow of fluid through the outlet ports of the valve and the flow restriction caused by the perforations therein, a radial force is applied to the filter. Such radial force must be resisted by the snap ring to maintain the filter in place in its annular groove to prevent loss of filtration capability and sudden pressure drops should the filter be lifted from the annular groove.

A problem with the arrangement shown in US 2004/0182450 A1 is that the snap ring only contacts the filter at a single central point across the width of the filter. Thus there is a risk that fluid pressure may cause the side edges of the plate to lift away from the annular groove, particularly in the region of overlap of the ends of the filter plate, causing a loss of filtration and a pressure drop and also an increased risk of vibration of the filter and potential failure of the filter plate.

According to the present invention there is provided a fluid control valve comprising a valve body having a central bore provided with a plurality of radial apertures defining inlet and outlet ports, and a spool slidably mounted within the central bore for axial movement therein to provide selective fluid communication between selected pairs or groups of the inlet and outlet ports, wherein at least one annular groove is formed in an outer periphery of the valve body in the region of one of said radial apertures, a filter being provided in said at least one annular groove, the filter comprising a perforated plate or membrane formed into a cylindrical shape and located in the annular bore, the perforated plate being held in place in the groove by retaining means, wherein the retaining means comprises an elongate resilient member located around the outer periphery of the perforated plate and adapted to apply a compressive biasing force against the plate, whereby, at any location around the periphery of the plate, the retainer contacts the plate at a least two points spaced apart from one another across the width of the plate.

In one embodiment the retaining means is in the form of a helical spring, Preferably the retaining means is in the form of a helical spring having at least two turns.

In an alternative embodiment the retaining means is in the form of a U-shaped clip defining a pair of spaced circular retaining portions connected together by an axially extending connecting portion. Preferably the connecting portion extends perpendicular to the retaining portions. Preferably the length of the connecting portion is substantially equal to the width of the groove.

Preferred embodiments of the present invention will now be described with reference to the accompanying drawings, in which:

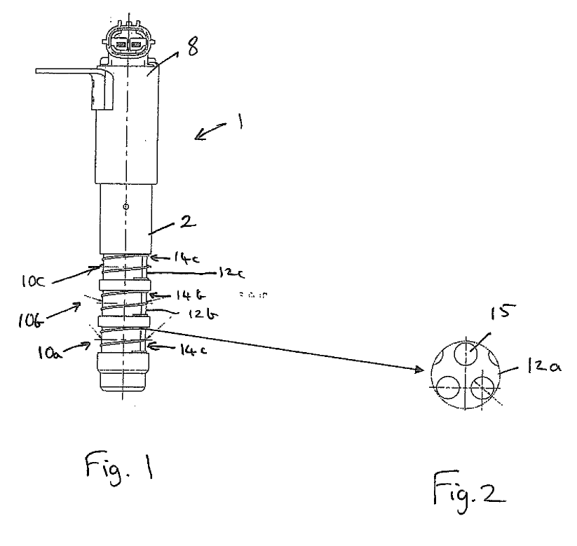

FIG. 1 is a side view of a fluid control valve according to a first embodiment of the present invention;

FIG. 2 is a detailed view of part of the filter plate of the valve of FIG. 1;

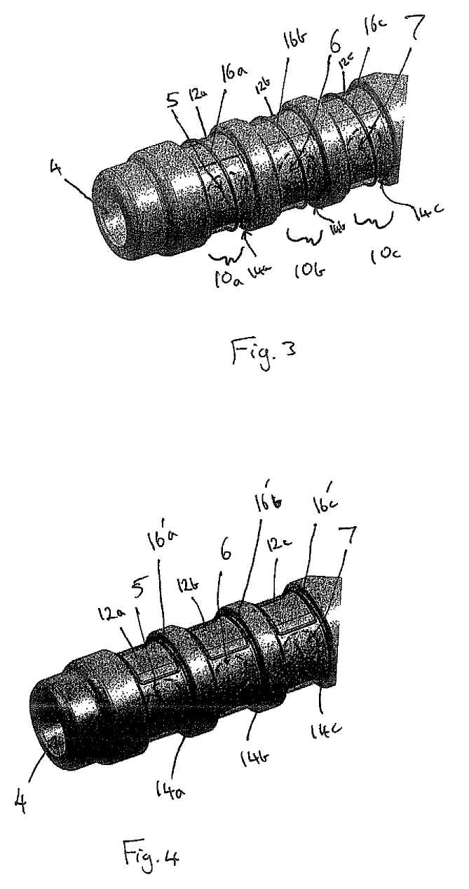

FIG. 3 is a detailed perspective view of the fluid control valve of FIG. 1;

FIG. 4 is a perspective view of a fluid control valve according to a second embodiment of the present invention.

A fluid control valve 1 according to the present invention comprises a cylindrical valve body 2 having a central bore 4 and being provided with radial apertures 5,6,7 defining inlet and outlet ports. A spool (not shown) is axially slidably mounted within the central bore 4 of the valve body 2 to provide selective fluid communication between selected pairs or groups of the inlet and outlet ports 5,6,7. The spool is axially moveable within the valve body by means of an electromagnetic actuator 8 for applying a driving axial force to the spool against the action of a return spring (not shown).

In order to avoid damage to the cam phaser mechanism a filter 10a,10b,10c is provided over at least an outlet port 5,6,7 of the valve body or over each of the ports (as shown). Each filter is in the form of a perforated plate 12a,12b,12c wrapped around the valve body and located in a peripheral annular groove 14a,14b,14c in the outer surface of the valve body in the region of the respective port or aperture to cover the aperture. The perforated plate comprises a thin sheet of steel having a plurality of perforations 15 formed therein (see FIG. 2) in the form of a strainer. The filter plate 12a,12b,12c is of sufficient length to be wrapped around the annular groove 14a,14b,14c with sufficient overlap to ensure a good seal while minimising pressure loss.

Each filter plate 12a,12b,12c is held in place in its annular groove 14a,14b,14c by means of a retainer 16a,16b,16c. In a first embodiment of the present invention, as illustrated in FIGS. 3 and 5, the retainer 16a,16b,16c is formed from thin spring steel bar bent into a helical form in the manner of a spring having two full turns. Each retainer 16a,16b,16c is mounted in a respective groove 14a,14b,14c so the free end of the retainer extend across the region of overlap of the filter plate 12a,12b,12c, pressing against the side or border regions of the filter plate 12a,12b,12c in said region of overlap with the middle region of the retainer 16a,16b,16c extending across a central portion of the region of overlap to prevent lifting or vibration of the ends of the filter plate 12a,12b,12c due to fluid flow therethrough. The retainer 16a,16b,16c thus provides a minimum of two spaced contact points across the width of the filter plate 12a,12b,12c at any point around the periphery of the groove, thus ensuring that the filter plate is held in place.

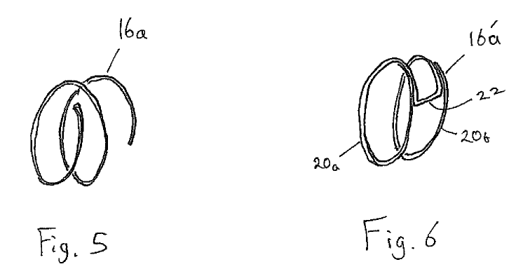

In a second embodiment of the present invention, as illustrated in FIGS. 4 and 6 the retainer is formed from thin spring steel bar bent into the form of a U-shaped clip defining first and second spaced apart circular retaining portions 20a,20b adapted to apply a compressive biasing force to side or border regions of the filter plate 12a,12b,12c with an axial connecting portion 22 extending perpendicular to the retaining portions 20a,20b. The connecting portion 22 has a length substantially equal to but slightly less than the width of the groove 14a,14b,14c. The retainer 16a′,16b′,16c′ is located in the groove 14a,14b,14c so that the connecting portion 22 extends over or adjacent to the region of overlap of the filter plate 12a,12b,12c. As with the first embodiment, the retainer 16a′,16b′16c′ of the second embodiment of the invention provides a minimum of two spaced contact points across the width of the filter plate 12a,12b,12c at any point around the periphery of the groove 14a,14b,14c, thus ensuring that the filter plate 12a,12b,12c is held in place.

The present invention ensures that the filter plate and associated retainer is well maintained in their associated groove and that the overlapping ends of the filter plate are firmly held in place in the groove by the retaining force provided by the retainer.

1. A fluid control valve comprising a valve body having a central bore provided with a plurality of radial apertures defining inlet and outlet ports, and a spool slidably mounted within the central bore for axial movement therein to provide selective fluid communication between selected pairs or groups of the inlet and outlet ports, wherein at least one annular groove is formed in an outer periphery of the valve body in the region of one of said radial apertures, a filter being provided in said at least one annular groove, the filter comprising a perforated plate or membrane formed into a cylindrical shape and located in the annular bore, the perforated plate being held in place in the groove by retaining means, characterized in that the retaining means comprises an elongate resilient member located around the outer periphery of the perforated plate and adapted to apply a compressive biasing force against the plate, whereby, at any location around the periphery of the plate, the retaining means contacts the plate at at least two points spaced apart from one another across the width of the plate.

2. The fluid control valve according to claim 1, characterized in that the retaining means is in the form of a helical spring.

3. The fluid control valve according to claim 2, characterized in that the retaining means is in the form of a helical spring having at least two turns.

4. The fluid control valve according to claim 1, characterized in that the retaining means is in the form of a U-shaped clip defining a pair of spaced circular retaining portions connected together by an axially extending connecting portion.

5. The fluid control valve according to claim 4, characterized in that the connecting portion extends perpendicular to the retaining portions.

6. The fluid control valve according to claim 5, characterized in that the length of the connecting portion is substantially equal to the width of the groove.
